(19) United States
(12) Patent Application Publication
(10) Pub. No.: US 2010/0230608 A1
(43) Pub. Date: Sep. 16, 2010

(54) SAFE MOTION

(75) Inventors: Paul Bengtsson, Goteborg (SE); Krister Svensson, Goteborg (SE); Håkan Olin, Sundsvall (SE); Mikael Von Dorrien, Molndal (SE)

Correspondence Address: BUCHANAN, INGERSOLL & ROONEY PC, POST OFFICE BOX 1404, ALEXANDRIA, VA, 22313-1404, US

(73) Assignee: NANOFACTORY INSTRUMENTS AB, Goteborg (SE)

(21) Appl. No.: 12/280,303

(22) PCT Filed: Mar. 2, 2007
(86) PCT No.: PCT/SE2007/000204

§ 371 Date: Oct. 8, 2008

(30) Foreign Application Priority Data
Mar. 2, 2006 (SE) 0600455-0

(51) Int. Cl. G21K 5/10

(52) U.S. Cl. 250/442.11

(57) ABSTRACT

The present invention relates to an inertial slider (10) and a method for safely and controllably approach an object (2) towards a fixed object (3) for instance inside a transmission electron microscope (101). The inertial slider is controlled with a control signal (201) with a timing characteristic faster than a mechanical resonance of the object to be moved. The inertial slider moves in a first step away from the fixed object and the movable object is moved relative the inertial slider in that first step.

### TECHNICAL FIELD

The present invention relates to a reversed inertial sliding device and in particular to a method of approaching a probe to a target using a reversed inertial sliding technique.

### BACKGROUND OF THE INVENTION

Current activities concerning nanotechnology research and product development are very active today. One of these research fields is the development of new instrumentation capable of working with and studying the behaviour of materials at the nanometre scale, as nanotechnology demands tools and involves objects of the order a few nanometres or even less. For instance, microscopy techniques, such as transmission electron microscopy (TEM) and scanning probe microscopy including scanning tunnelling microscopy (STM), atomic force microscopy, and other related techniques are capable of measuring surface details of this order on objects. However, these techniques require a very accurate positioning of the measuring probes. For this purpose, piezoelectric positioning devices using an inertial sliding effect may be used. Inertial motors operate according to the following principle: An object is attached to a piezoelectric scanning device by frictional forces only. When the piezoelectric scanning device is moved forward, the object follows suite forward. Abruptly, the scanning device reverses the direction of movement and due to the rapid reversal, the object does not reverse its direction immediately and, consequently the object is moved slightly in relation to the scanning device. These types of inertial motors use two different techniques for movement, the first is as described above for large steps (in the order of a few micrometers) and a second technique wherein the voltage on the piezoelectric scanning device is adjusted, deflecting it in different directions. The latter movement can be controlled within a resolution of a few tenths of a nanometer or even less. Thus, it is possible with a resolution on the nanometer scale or even better, to have movements of up to several millimetres representing a huge dynamic range, useful for examining macro scaled objects with nanometer details.

The prevailing technique pertaining to inertial motors present today is that a sliding object, e.g. a probe, is moved forward towards a target object by a piezo electrically controlled inertial sliding device which is then rapidly withdrawn away from the target object and the probe is thus slightly closer to the target sample with respect to the piezoelectric device. However, as discussed below, there is a potential risk when approaching a target object with this type of technique as there is a possibility that the surface of the probe hits the target object during the forward movement. An inertial slider often has two different modes of operation: one inertial sliding mode and one nano positioning mode. The inertial sliding mode involves a relative movement between the sliding object attached to the piezoelectric scanning device by utilizing the object's inertia. This type of movement involves steps up to the micrometer range and is normally not well controlled. In contrast the nano positioning mode involves only a movement of the piezoelectric scanning device in such a way as to not change the relative position between the scanning device and the sliding object. This is done for instance by extending, retracting or deflecting the scanning device slowly wherein the sliding object does not slide but follows suite in the same direction as the scanning device. In this type of movement the change of position in relation to the environment is in the nanometer range or even smaller, depending on the type of piezo electrical scanning device, noise, temperature change, and other parameters.

Often it is of interest to view an object by scanning a probe sensitive to surface features over the surface of the object (e.g. Scanning tunnelling microscopy STM, or atomic force microscopy AFM, both members of the scanning probe microscopy family), or positioning a probe close to the object of interest for other measurements (e.g. electric, magnetic, or similar). In this process the probe needs to be positioned close to the surface of the target object, and, depending on the measurement required, finally be brought into contact with the object. Since the scale is very minute this can not be achieved using optical microscopy techniques. Instead electron microscopy techniques may be used for imaging the probe surface distance or, when using an electrical conducting probe, the probe can be positioned precisely by measuring the electrical characteristics of the probe which will change significantly when it is brought close to, or in contact with the surface/object.

Various motors have therefore been developed of which one example is the inertial sliding motor (D. W. Pohl, Rev. Sci. Instrum. 58 (1987) 54). One drawback with these inertial sliding motors is that you need a rather high inertia of the moving object in order for the motor to work. An even bigger problem is that in order to approach an object, such as a surface, the moving object (slider) will temporarily move much further than the resulting step-length. Thereby the sliding object will temporarily be well ahead of its stationary position, making it almost impossible to approach a desired target without risking damage to at least one of the two objects (see FIG. 2a). Thus a system where the sliding object is controlled during the entire positioning operation would be desirable.

It is therefore an object of the present invention to provide a nano positioning method that reduces the risk of damaging the parts present.

### SUMMARY OF THE INVENTION

This object is achieved by suggesting a novel control signal for a reversed approach method, wherein the piezoelectric scanning device moves in the opposite direction with respect to the intended direction of movement of the object (slider). If the backward movement of the piezoelectric scanning device is rapid the object will move in the forward direction with respect to the piezoelectric device. Here we present a novel waveform (relying on fast control electronics) and a method that enables us to move low inertia objects in as safe way, i.e. such that the slider is never ahead of its stationary position and full control of the sliding object is maintained. In order to realize such a controlled reverse motion it is necessary to use a pulse shape faster then the mechanical resonance frequency of the combined system.

The present invention is realized a number of aspects, wherein a first aspect, a method of micro positioning an object in relation to an acceleration unit using an inertial sliding principle is provided, comprising the step of:
applying a control signal to said acceleration unit for obtaining a relative movement between said sliding object and said acceleration unit; said control signal having a timing characteristic faster than a mechanical resonance frequency of said sliding object, said movement of the acceleration unit being generated in an opposite direction of the travel of said sliding object in an initial step of said inertial sliding process and said relative movement being further performed during said initial step.

The method may further comprise the step of testing if said sliding object is close to a target object, which in turn may comprise the steps of
applying a control signal to said acceleration unit for extending said sliding object towards said target object without any relative movement between said sliding object and said acceleration unit;
determining if said sliding object is at a desired position with respect to said target object; and
applying a control signal to said acceleration unit for retracting said sliding object away from said target object;

The acceleration unit (1) control signal may have a maximum voltage amplitude of approximately 15 V.

Another aspect of the present invention, a computer program stored in a computer readable medium for controlling a piezoelectric positioning device is provided, comprising instruction sets for applying a control signal for inertial sliding of a sliding object relative an acceleration unit wherein said control signal is faster than a mechanical resonance frequency of said sliding object, said movement of the acceleration unit being generated in an opposite direction of the travel of said sliding object in an initial step of said inertial sliding process and said relative movement being further performed during said initial step.

Yet another aspect of the present invention, a signal for controlling an acceleration unit used for moving a sliding object relative said acceleration unit using an inertial sliding principle is provided, characterized in that an initial part of said signal is faster than a mechanical resonance frequency of said sliding object; said signal comprise at least two parts: said initial part for moving said sliding object relative said acceleration unit and a subsequent part for moving said sliding object and acceleration unit together relative an environment. The signal is further arranged for moving said sliding object relative said acceleration unit in the opposite direction with respect to the intended direction of movement of said sliding object in an initial step of said inertial sliding process and said relative movement being further performed during said initial step.

The time duration of said initial part is of the order at least 10 times shorter than said subsequent part.

These and other aspects of the invention will be apparent from and elucidated with reference to the embodiments described hereinafter.

### BRIEF DESCRIPTION OF THE DRAWINGS

In the following the invention will be described in a non-limiting way and in more detail with reference to exemplary embodiments illustrated in the enclosed drawings, in which:

FIG. 1 is a schematic illustration in perspective of an inertial sliding device principle according to the present invention;

FIG. 2a illustrates schematically a control signal according to the related art and FIG. 2b a control signal from a reversed inertial sliding device according to the present invention;

FIG. 3 illustrates schematically a TEM sample holder with an inertial sliding device according to the present invention;

FIG. 4 illustrates a TEM/STM measurement system with an inertial sliding device according to the present invention;

FIG. 5 is a schematic illustration of a processor controlling the control signal from the inertial sliding device according to the present invention; and

FIG. 6 is a schematic illustration of a method of controlling the control signal from the inertial sliding device according to the present invention.

### DETAILED DESCRIPTION OF PREFERRED EMBODIMENTS

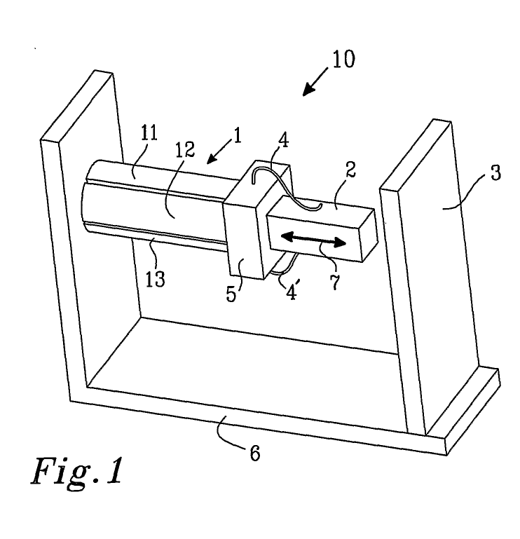

In FIG. 1, reference numeral 1 generally denotes a scanning device or acceleration unit 1 with a mounting device 5 for holding a sliding object 2. The sliding object 2 may be attached to the mounting device 5 with a holding structure 4. The scanning device 1, mounting device 5, optional holding structure 4 and 4′ and sliding object 2 constitute an inertial slider arrangement 10. The purpose is to slide the sliding object 2 relative the mounting device 5/scanning device 1, for instance towards a target object 3. The target object 3 and scanning system 10 may be connected to each other mechanically via a frame structure 6. FIG. 1 illustrates the key components for the understanding of the basic operation of the scanning arrangement 10, but other parts have been excluded in the figures as understood by the person skilled in the art. Excluded components include for instance electrical wires to the scanning device and sliding object (if needed), connectors to external or internal control and/or analysis instrumentation, insulators between components, and protective casing around the system or parts of the system, all depending on the actual application of the present invention. Arrow 7 shows an example of direction of travel for inertial sliding of the sliding object; however, other directions are possible by moving the acceleration unit 1 in other directions; for instance travel in directions parallel to the target object 3.

The present invention involves a technique for moving a sliding object 2 relative a fixed object 3, e.g. a probe 2 relative a target 3 during different types of testing or experimentation within for instance nanotechnology studies. The method relies on a very fast motion of the piezoelectric element 1 and the present invention induces motion in the piezoelectric element 1 in a direction which is opposite to the desired motion of the sliding object. In order to obtain a forward movement for the sliding object, it is crucial to have very fast control electronics, and a high mechanical resonance frequency of the piezoelectric element in order for the piezoelectric element to accurately follow the fast control signals fed to it. The piezoelectric element 1 may comprise one or several electrodes 11, 12, 13, e.g. for a tube element 1 five electrodes may be present: four on the outer part of the element 1 and one on the inner part of the element 1; only three of the outer electrodes 11, 12, 13 is visible in FIG. 1. If a voltage is applied to any of the outer parts of the element 1, it will be deflected in a direction substantially perpendicular from the electrode surface and if a voltage is applied to the inner part the element 1, it will be elongated or retracted along an axis substantially along the tube length. If a positive voltage is applied to one electrode (say electrode 11) and at the same time a negative voltage to an opposing electrode 13, the deflection will be greater than if only one electrode was subjected to a voltage.

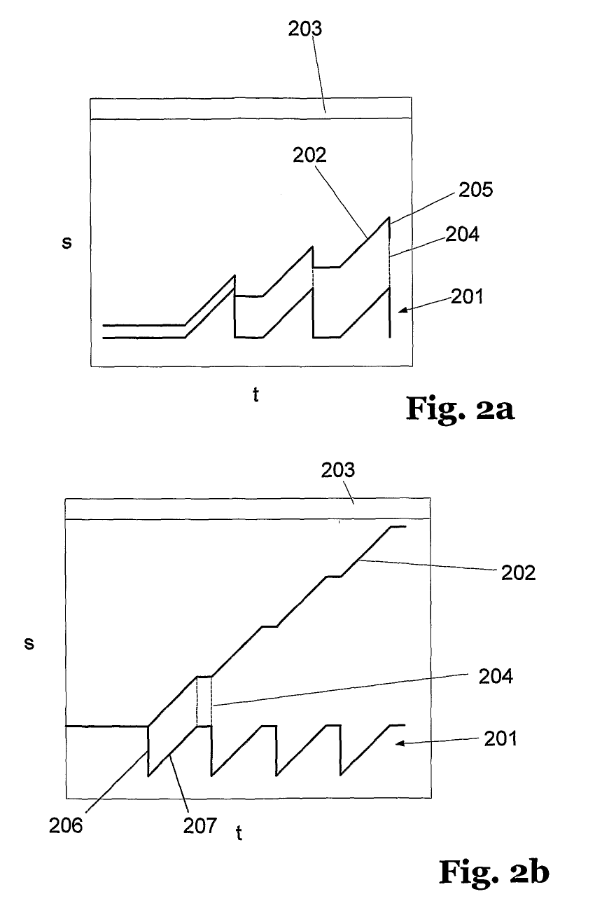

General motion according to known techniques are shown in FIG. 2a (a schematically motion diagram, i.e. distance of sliding object 2 to target object 3 versus time diagram), wherein reference numeral 201 denotes motion of the scanning device (e.g. a piezo electric device) 1, 202 motion of the sliding object 2 and 203 denotes the target object 3. Reference numeral 205 illustrates how the sliding object 2 follows the scanning device 1 a short distance back during inertial sliding which is present in these types of configurations.

The motion 202 of the piezo has been slightly offset in the diagram of FIG. 2a in order to separate the motion due to the first cycle of the piezo control signal from the motion 202 of the sliding object 2.

FIG. 2b is a schematically motion diagram according to the present invention, where the same objects are shown with the same reference numerals as for FIG. 2a. In FIG. 2b it can be seen that as the rapid motion 201 of the piezoelectric element is always opposing the desired motion 202 of the sliding object when approaching the target 203, there is no risk of collision between the sliding object and the target during the motion. The return movement 205 that can be found in FIG. 2a is not present in the movement according to the present invention as can be seen in FIG. 2b. The control signal part 206 used for inertial sliding supplied to the system are faster than the mechanical resonance frequency of the system 10, including the probe, or at least of the same order, ensuring that the sliding object is kept still during the inertial sliding procedure. In the present set up this means that the sliding object will not vibrate along with the excitation at the excitation frequency but rather remain essentially in a fixed position relative the environment. The return part of the control signal 207 should be slower than the mechanical resonance frequency of the system 10. In one embodiment of the present invention the inertial sliding part 206 of the control signal (i.e. the initial part) is of the order a few microseconds in duration and the return part 207 of the control signal (i.e. the subsequent part) is of the order a few milliseconds of duration, i.e. the inertial sliding part 106 is a factor 10 faster than the second part 207; however, it should be understood by the person skilled in the art that any other relationship and timings may be utilized depending on the mechanical configuration. This type of inertial sliding may be called resonant mode.

In FIG. 2b the detailed shape of the waveform 201 of the pulses fed into the piezoelectric element, may vary depending on the resonance frequency of the piezoelectric element and sliding object, which will further improve the motion of the sliding object 201. Also, the detailed shape of the waveform at its turning point, i.e. the time right before the piezoelectric element is jerked in the backward direction, can be made smooth in order to gently slow down the slider and bring it to rest in-between each successive step. For instance a saw tooth shaped excitation signal may be utilized; however, other excitation signals may be utilized, for instance exponentially shaped signals such as a cycloidical signal.

It should be understood by the person skilled in the art that the scaling between the motion of the sliding object 2 and the piezo 1 in FIGS. 2a and b need not be according to scale. Also the different timings of the different parts of the cycles are not shown in scale but may vary depending on configuration and type of control signal applied to the piezo.

Let us now compare the two diagrams with each other. Whereas the motion of the piezo in FIG. 2a starts towards the target object 203, it starts away from the target object in FIG. 2b. In order to make the sliding object 2 not follow the piezo movement when the piezo returns to the starting position, the piezo movement towards the target object 3 need to be quite rapid in order to provide the sliding object 2 with a speed towards the target object 3 that gives the sliding object 2 the mechanical inertia that is necessary for it to not be affected when the piezo 1 returns. The return acceleration and speed of the piezo 1 need also be large enough in order to provide relative movement between the sliding object 2 and the piezo 1. In the present invention only the first step 206 of the control signal need to have a rapid acceleration and velocity, the return signal can have any timing characteristics as long as it is not so rapid as to again provide relative movement between the piezo 1 and the sliding object 2. As can be seen from FIGS. 2a and b the motion of the sliding object 202 is more controlled and all large rapid movements are away from the target object 203 reducing the risk of accidental collision.

During the slow moving phase of the slider, the distance to the target can be continuously checked by monitoring a tunnelling current between slider and target (which are set at different electrical potentials). If a current is detected then the motion can be immediately interrupted while the two objects are still a few Angstroms apart, thus avoiding any damage to the slider or target. It is also possible to use the imaging system of the TEM in order to deduce the distance between the probe and target visually, ensuring a safe approach of the probe towards the target (or vice versa if the target is moved using the inertial slider motor).

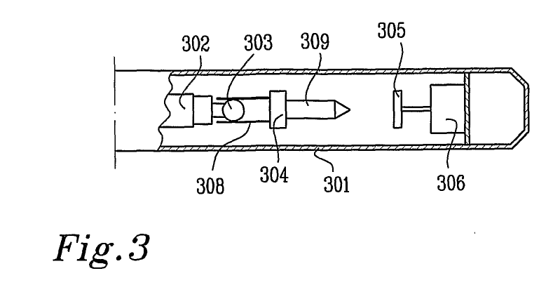

In Transmission Electron Microscopy (TEM) it is crucial to position the probe and the target object very precisely, within the range of a few Angstroms, in order to obtain accurate measurements. Thus, this is a technique wherein the reversed inertial slider is very useful. FIG. 3 shows an enlarged view of a TEM sample holder with the reversed inertial slider device according to the present invention, this embodiment of inertial slider has been discussed in U.S. Pat. No. 6,452,307 which is incorporated by reference into this application. In FIG. 3 a sensor probe 309 is attached to a slider 304. The piezoelectric element operates with the reversed inertial motion principle described as the waveform in FIG. 2b, wherein the slider 304 is mounted on a ball 303 with a plurality of spring legs 308. The ball 303 is rigidly mounted on a piezoelectric device 302 with one or several possible directions of movement depending on the number of electrodes present on the piezoelectric device 302. When a voltage is applied to an electrode on the piezoelectric device 302, the ball is made to deflect in a certain direction. The ball 303 may thus be rapidly retracted by applying a voltage to the electrode on the piezoelectric device 302. By inertial forces the slider 304 with the probe 309 may thus be made to move relative the ball 303 in the direction of the target 305 and sample holder 306. By repeating this movement it is possible to move the slider 304 with the probe 305 forward, backwards, or in different directions depending on the applied voltage to the piezoelectric device 302. This inertial slider motion principle induces “large” translations up to several micrometers in range. Smaller movements may be produced by applying voltages to only one or several electrodes on the piezoelectric device 302; this may give movements with an accuracy of the order sub-Angstroms. The “large” translations involve relative movement between the piezoelectric device 302 and the sample 306, whereas the smaller movements involve only bending or elongation/contraction of the piezoelectric device 302 and no relative movement between the piezoelectric device 302 and the probe 305. In one embodiment of the present invention, a sensor probe is mounted on the piezo driven inertial slider 304. The invention is not limited to the above described design as it is also possible to switch places between the target and the probe, i.e. to mount the target on the piezo driven inertial slider 304 and the sensor probe on the frame 301 of the TEM sample holder 300. In this case, the end part of the TEM sample holder wherein the sensor and probe reside may be electrically shielded using a Faradays cage in order to reduce unwanted electrostatic build up due to exposure to the electron beam. Such a shield has an opening through which the probe protrudes. A Faradays cage may be utilized around the target as well of course wherein the cage comprises two openings for the electron beam to enter and exit.

It should also be understood by the person skilled in the art that other solutions are possible regarding the ball 303 wherein other geometrical structures may be utilized, for instance if only movements in two directions are needed, a cylinder shaped form may be used.

The probe holding structure may be constructed in several ways as understood by the person skilled in the art, as long as the probe (or probe holding structure) is movable relative to the piezo electrical device. In a similar manner the target holding structure may be constructed in any suitable manner as long as it is kept essentially fixed with respect to the frame.

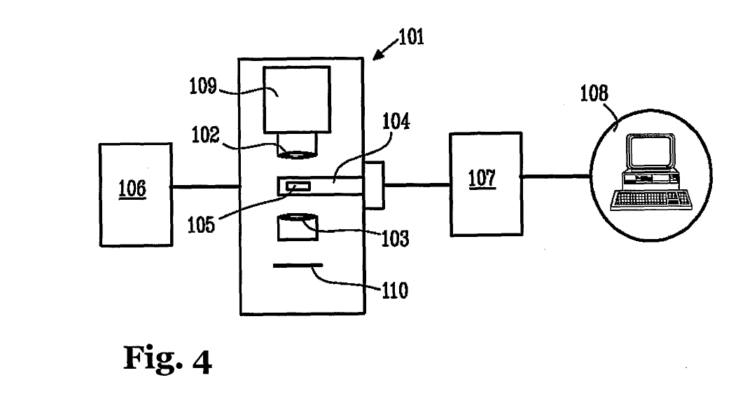

FIG. 4 illustrates a schematic view of a TEM/STM measurement system with the reversed inertial slider device according to the present invention. In a preferred embodiment of the present invention a probe 405 mounted on a piezo driven slider 304 (as described in FIG. 3) is mounted on a TEM sample holder 404. The piezo driven slider operates according to the reversed inertial sliding principle described in FIG. 2b and the movement and measurement data from the probe as it approaches the target are acquired using a measurement system comprising control electronics 407 and a computational system 408 comprising e.g. a personal computer, display unit and interface peripherals (such as a keyboard and mouse).

The TEM 401 operates by forming a beam of electrons directed towards a sample and after interaction with the sample, the electron beam is directed towards an image viewing or collecting device 410, using magnetic lenses 402 and 403 respectively. The electron beam is produced using an electron emitting device 409. The TEM 401 is controlled by a TEM control system 406 as understood by the person skilled in the art. However, it is possible to combine the probe control system 408 with the TEM control system 406 or the probe control system 408 may be arranged with an interface so as allow the TEM control system 406 control of the probe control system 408. The present invention may be used in any type of standard or non standard TEM solution, e.g. standard TEM's such as TEM instruments from the FEI Tecnai series or JEOL JEM 2010 series. FEI and JEOL are two of the largest TEM manufacturers in the world. Care need to be taken in design of the probe holder so it will fit in situ of the TEM.

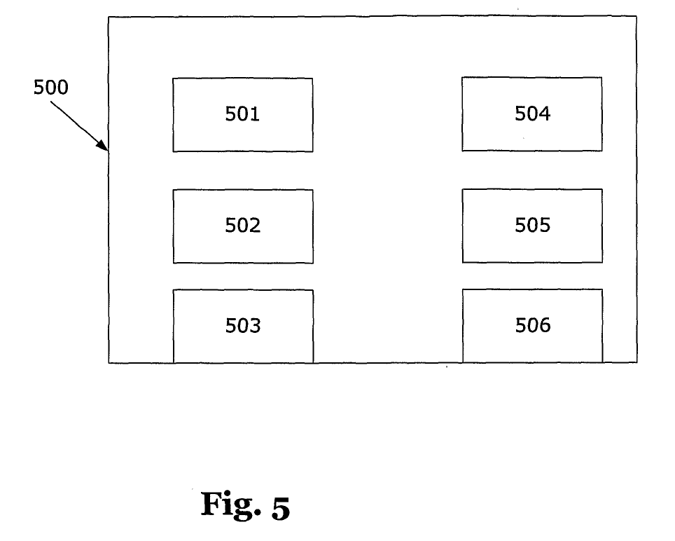

FIG. 5 illustrates a processor controlling the movement and measurement signal 500 for use in a measurement setup according to the present invention. The measurement device 500 may comprise a processing unit 501, such as a microprocessor, FPGA (Field Programmable Gate Array), ASIC (Application Specific Integrated Circuit), or DSP (Digital Signal Processor), one or several memory units 502 (volatile (e.g. RAM) or non-volatile (e.g. hard drive)), and a data sampling unit 503 obtaining data either directly or indirectly from the experimental setup. Data may be obtained through direct sampling with an A/D converter (analog to digital) or collected from another pre-processing device (not shown) and obtained through a communication link (not shown) such as Ethernet or a serial link. The measurement device 500 may further optionally comprise a communication unit 506 for communicating measurement data sampled, analyzed, and/or processed to another device for display or storage purposes for instance. Also the measurement device 500 may further comprise a pre-processing unit 504 and a measurement control unit 505.

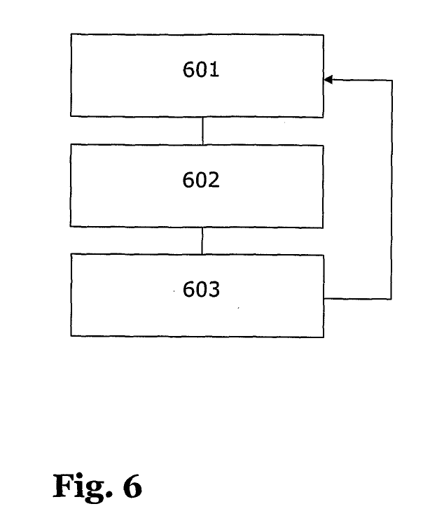

FIG. 6 illustrates a method according to the present invention.
A control voltage is gradually applied to the piezo so as to extend it to an extended position towards the target while the control electronics monitor a signal from the probe in order to determine if the probe is close to the target or possibly in contact, step 601.
If no such signal is detected the piezo is withdrawn away from the target a certain distance, step 602.
An inertial sliding pulse voltage is applied to the piezo so as to rapidly move the piezo and probe holding structure away from the target. Due to the inertial moment of the probe, the probe and probe holding structures will stay fixed relative the target. Since the probe holding structure moves, the probe and probe holding structure will have moved relative each other, step 603
The method is then repeated with step 1, wherein the probe is slowly extended towards the target while the control electronics monitor the signal from the probe, step 601. These steps are repeated until the probe is positioned at a desired position relative the target.

An advantage of the present invention is for instance that since the movement is very small and it is possible to acquire the movement using small voltages, no high voltage equipment is necessary, considerably reducing costs of systems, if only inertial sliding movement or small nano positioning are required. Using the present invention the step lengths will be very small, of the order 100 nanometer scale or below. Control signal amplitudes applied to the piezo may be below 15 V, thus enabling low voltage equipment. However, it is possible to use high voltage control signals in order to have larger relative movement between the sliding object 2 and the scanning device 1 and provide larger deflections of the scanning device as well. Such high voltage equipment often operate at 150 V or even up to 300 V if two opposing electrodes of the scanning device 2 operate at different voltages (e.g. +150 Von one electrode and −150 V at the other electrode). Even higher voltages may be applied depending on the configuration of the scanning device 2; however, there is an upper voltage limit that they may operate at before they break down which depend on the material used in the scanning device 2.

Since the pulses are faster than the mechanical resonance frequency of the system components will not move in any uncontrolled mariner, which gives a very accurate and safe motion control.

The invention is not limited to mounting a probe on the piezo side of the system; it is just as possible to mount the sample at the piezo side and having the probe being fixed with respect to the surrounding fixture.

It should be understood by the person skilled in the art that the invention may be used within any field of technology where high positioning precision is of desire and not limited to scanning probe technologies or electron microscopy applications.

In this description, the term “probe” is intended to mean an object that may be used for one or several types of operations in a controlled manner. For instance the probe may be an object with a pointy tip that can be brought into contact with a surface or another object in order to measure some electrical characteristics, e.g. conductivity or other characteristics, like force interactions. It may for instance be an STM or AFM tip.

The term “target object” is intended to mean for instance a surface or object where a probe is to be brought into contact with or be brought into close vicinity of.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented in part by means of both hardware and software, and that several “means”, “devices”, and “units” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

1. A method of micro positioning an object in relation to an acceleration unit using an inertial sliding principle, comprising the steps of:
applying a control signal to said acceleration unit for obtaining a relative movement between said sliding object and said acceleration unit; said control signal having a timing characteristic faster than a mechanical resonance frequency of said sliding object, said movement of the acceleration unit being generated in an opposite direction of the travel of said sliding object in an initial step of said inertial sliding process and said relative movement being further performed during said initial step.

2. The method according to claim 1, further comprising the step of testing if said sliding object is close to a target object.

3. The method according to claim 2, wherein said step of testing comprises the steps of:
applying a control signal to said acceleration unit for extending said sliding object towards said target object without any relative movement between said sliding object and said acceleration unit;
determining if said sliding object is at a desired position with respect to said target object; and
applying a control signal to said acceleration unit for retracting said sliding object away from said target object;

4. The method according to claim 1, said acceleration unit control signal having maximum voltage amplitude of approximately 15 V.

5. A computer program stored in a computer readable medium for controlling a piezoelectric positioning device, comprising instruction sets for applying a control signal for inertial sliding of a sliding object relative an acceleration unit wherein said control signal is faster than a mechanical resonance frequency of said sliding object, said movement of the acceleration unit being generated in an opposite direction of the travel of said sliding object in an initial step of said inertial sliding process and said relative movement being further performed during said initial step.

6. A signal for controlling an acceleration unit used for moving a sliding object relative said acceleration unit using an inertial sliding principle, characterized in that an initial part of said signal is faster than a mechanical resonance frequency of said sliding object; said signal comprise at least two parts: said initial part for moving said sliding object relative said acceleration unit and a subsequent part for moving said sliding object and acceleration unit together relative an environment.

7. The signal according to claim 6, wherein time duration of said initial part is of the order at least 10 times shorter than said subsequent part.

8. The signal according to claim 6 wherein said initial part of said signal is arranged for moving said sliding object relative said acceleration unit in the opposite direction with respect to the intended direction of movement of said sliding object in an initial step of said inertial sliding process and said relative movement being further performed during said initial step.
